(19) United States
(12) Patent Application Publication
(10) Pub. No.: US 2026/0115736 A1
(43) Pub. Date: Apr. 30, 2026

(54) ELECTROSTATIC DUST COLLECTION DEVICE AND AIR PURIFICATION APPARATUS

(71) Applicant: Suzhou Beiang Smart Technology Co., Ltd., Jiangsu (CN)

(72) Inventors: Yaoyuan LU, Jiangsu (CN); Qidong ZHANG, Jiangsu (CN); Junyi WU, Jiangsu (CN)

(73) Assignee: Suzhou Beiang Smart Technology Co., Ltd., Jiangsu (CN)

(21) Appl. No.: 19/124,380

(22) PCT Filed: Oct. 14, 2024
(86) PCT No.: PCT/CN2024/124800

§ 371 Date: Apr. 25, 2025

(30) Foreign Application Priority Data
Sep. 13, 2024 (CN) 202411286216.9

(51) Int. Cl. B03C 3/86; B03C 3/47

(52) U.S. Cl. CPC B03C 3/86; B03C 3/47

(57) ABSTRACT

The present disclosure relates to an electrostatic dust collection device and an air purification apparatus, including: a first electrode sheet and a second electrode sheet respectively in the form of a strip, wherein a plurality of first support bosses are respectively arranged on two sides of a first surface of the first electrode sheet; a plurality of second support bosses are respectively arranged on two sides of a first surface of the second electrode sheet; and after a second surface of the first electrode sheet is contacted and stacked on the second support bosses of the second electrode sheet, the electrostatic dust collection device is formed by winding.

### CROSS-REFERENCE TO RELATED APPLICATION

The present disclosure claims priority to Chinese patent Application No. 202411286216.9, filed with the Chinese Patent Office on Sep. 13, 2024, entitled “ELECTROSTATIC DUST COLLECTION DEVICE AND AIR PURIFICATION APPARATUS”, the entire contents of which are incorporated herein by reference.

### TECHNICAL FIELD

The present disclosure relates to the technical field of electrostatic dust collection, and in particular to an electrostatic dust collection device and an air purification apparatus.

### BACKGROUND ART

The electrostatic dust collection technology module is generally divided into the following two parts.

<1> A corona device for ionizing the air, the device charging the air by the action of high-voltage ionization, is known as a discharge electrode, an ionization electrode, or a corona device, etc.

<2> A dust collection device collecting particulate matter in the air, by which the moving charged particles are deposited on the electrode plate through the action of electric field force, is known as a collection electrode, or a dust collection electrode.

The dust collector arranged by metal plates (or electrically conductive plates) has been developed quite well, but it is limited in use due to drawbacks.

\textcircled{1} Due to issues such as the discharge spark, the spacing between exposed metal plates is too large, and a high voltage cannot be applied, so it is difficult to improve the filtration efficiency of the dust collection at one time.

\textcircled{2} The collection electrode module arranged by rectangular metal plates is usually in a cuboid shape. When matching with a circular fan or air duct section, the effective area beside the square inscribed within the circle is often wasted, and it is difficult to apply to the machine with an industrial design of a cylindrical-style appearance.

Therefore, the technicians have researched disc-shaped collection electrodes other than rectangular collection electrodes, and the basic principles are as follows.

The dust-collecting filter of the disc-shaped collection electrode is formed by two non-contacting electrodes wound together, and a gap air duct is formed between the electrodes. Different voltages are applied to the two electrodes, so as to form an electric field that is sufficient to absorb charged ions between the two electrodes. Under the action of the electric field force, the dust with different polarities moves towards electrodes with different polarities and is deposited on the electrodes, so that the dust and the gas can be separated.

The disc-shaped collection electrode has the following three advantages in principle.

\textcircled{1} The spacing between the electrodes can be made very small. The conductive layers of the two electrodes are isolated by the winding substrate with a thickness. Even if a very high voltage (usually 3˜10K) is applied, there will be no discharge spark phenomenon, and the dust collection efficiency is very high.

\textcircled{2} Disc winding electrodes, by selecting the length and width of the electrode winding substrate, can be wound into required disc electrodes of different diameter sizes and thickness sizes according to air duct requirements, which is easy to operate and inexpensive.

\textcircled{3} The disc-shaped collection electrode can be matched perfectly with the circular air duct. When the rectangular collection electrode is matched with the circular fan air duct, a “round-to-square” flow adapter is required for connection. Even so, the wind speeds, static pressures, and flow fields between various electrode plates of rectangular collection electrodes are different, which results in an inconsistent purification efficiency.

Although the above disc-shaped collection electrode has such advantages, the disc-shaped collection electrode is still not widely used. Through long-term testing, the inventor of the present disclosure found that the core issue affecting the dust collection efficiency and the assembly process relies on how to ensure uniform and equal spacing between winding layers. Only uniform and equal spacing can form a balanced and stable working electric field.

Under the premise of not affecting the electric field strength, the thickness of the winding layer substrate itself is very thin (generally 0.1˜0.5mm). After multiple layers of winding and extrusion, it is difficult to ensure the spacing between the two electrodes, which often results in issues such as flattening and stacking. For this reason, there are three conventional solutions as follows.

\textcircled{1} Melt adhesive: as shown in FIG. 1, when two adjacent electrostatic dust collection sheets are spirally wound and molded by using a specific tooling, an appropriate amount of hot melt adhesive 100 is added from its side surface when maintaining the spacing; and after the hot melt adhesive 100 is cooled and cured, it can play a role of fixing the spacing of electrostatic dust collection.

Drawbacks are as follows: <1> the specific tooling itself for maintaining spacing is more complex, and it has a higher failure rate in the winding process;
<2> dispensing cooling duration is long, which is not conducive to the improvement of production efficiency;
<3> when cleaning the dust collection electrode, the position of the dispensing has temperature requirements, and the dispensing position is easily damaged; and
<4>the number of adhesive strips for dispensing is limited, and at the position without dispensing, since the suspended length of the dust collection sheet is relatively long and the dust collection sheet has a thinner thickness, when the dust collection sheet is deformed due to external forces such as extrusion and collision, the dust collection spacing will no longer be guaranteed, and there is a risk of short circuit since two sheets are attached.

\textcircled{2}) Spacer: as shown in FIG. 2, when two adjacent electrostatic dust collection sheets are ready to be wound, a spacer 200 of a certain thickness is first attached to one of the winding substrates, and the spacer 200 is attached to the substrate at a certain distance; the spacer 200 plays a role of fixing the spacing of electrostatic dust collection during the winding process; and it can also directly insert the spacer 200 into a gap of the winding tape during the winding process to play a role of fixing the spacing.

Drawbacks are as follows: <1> it needs thousands of spacers 200 for winding a circular collection electrode, which is complicated for either attachment or insertion.

<2> the attachment or insertion of spacers 200 covers a part of the space of the dust collection electric field, where the wasted dust collection efficiency in the collection electrode also increases due to the large number of spacers 200.

\textcircled{3}) Isolation comb: as shown in FIG. 3, a first electrostatic dust collection sheet and a second electrostatic dust collection sheet are wound into a double helix linear structure with uniform spacing by using the tooling; a comb-shaped support plate 300 as shown in the figure is inserted into the formed double helix linear structure; and a plurality of combs are arranged with equal spacing on the comb-shaped support plate 300.

Drawbacks are as follows: <1> the specific tooling for maintaining spacing is more complex, and it has a higher failure rate in the winding process;
<2> the groove width of the comb-shaped support plate 300 is influenced by mold processing and strength life, wherein the groove width (>1mm) is much larger than the thickness of the winding substrate, which results in a clearance fit between the substrate and groove; and this is unfavorable for ensuring the fixed spacing;
<3> the act of precisely inserting the comb-shaped support plate 300 into the wound double helix substrate is a high requirement;
<4> the number of adhesive strips for dispensing is limited, and at the position without dispensing, since the suspended length of the dust collection sheet is relatively long and the dust collection sheet has a thinner thickness, when the dust collection sheet is deformed due to external forces such as extrusion and collision, the dust collection spacing will no longer be guaranteed, and there is a risk of short circuit since two sheets are attached.

In summary, it can be seen that the disc electrostatic dust collection sheets in the prior art are unable to effectively maintain the spacing between two electrostatic dust collection sheets after spiral winding and molding.

### SUMMARY

The technical problems to be solved by the present disclosure include the following, for example, the problem that the disc electrostatic dust collection sheets in the prior art are unable to effectively maintain the spacing between two electrostatic dust collection sheets after spiral winding and molding. Therefore, the present disclosure provides an electrostatic dust collection device and an air purification apparatus, wherein, during the winding and molding process, a fixed spacing can be precisely maintained without the need for specific tooling to maintain a fixed gap. After the winding and molding process, a layered support structure can be formed, which solves the problem of difficulty in ensuring the spacing between the two electrostatic dust collection sheets after the spiral winding and molding. Moreover, the product can be assembled once the winding is completed, and there is no need for a subsequent processing step, such as dispensing or inserting the isolation comb.

To solve the above technical problems, the present disclosure provides an electrostatic dust collection device, including: a first electrode sheet and a second electrode sheet that are respectively in the form of a strip, wherein a plurality of first support bosses are respectively arranged on two sides of a first surface of the first electrode sheet; a plurality of second support bosses are respectively arranged on two sides of a first surface of the second electrode sheet; and after a second surface of the first electrode sheet is contacted and stacked on the second support bosses of the second electrode sheet, the electrostatic dust collection device is formed by winding.

In the embodiments of the present disclosure, the first electrode sheet includes: a first substrate and a first conductive layer arranged on one side surface of the first substrate, wherein the plurality of first support bosses are arranged on two sides of the first conductive layer, and the plurality of first support bosses are at the same spacing from the first conductive layer;

the second electrode sheet includes: a second substrate and a second conductive layer arranged on one side surface of the second substrate, wherein the plurality of second support bosses are arranged on two sides of the second conductive layer, and the plurality of second support bosses are at the same spacing from the second conductive layer.

In the embodiments of the present disclosure, the first support bosses are arranged extending in a transverse direction of the first electrode sheet, wherein a width of one side of the first support bosses close to the first conductive layer is smaller than a width of one side of the first support bosses away from the first conductive layer, and the one side of the first support bosses away from the first conductive layer is disposed in the form of a circular arc; and
the second support bosses are arranged extending in a transverse direction of the second electrode sheet, wherein a width of one side of the second support bosses close to the second conductive layer is smaller than a width of one side of the second support bosses away from the second conductive layer, and the one side of the second support bosses away from the second conductive layer is disposed in the form of a circular arc.

In the embodiments of the present disclosure, the first support bosses and the first substrate are integrally molded; and
the second support bosses and the second substrate are integrally molded.

In the embodiments of the present disclosure, after the first electrode sheet and the second electrode sheet are wound and molded, the first support bosses on the first electrode sheet and the second support bosses on the second electrode sheet, which are in adjacent layers, are staggered to each other.

In the embodiments of the present disclosure, the two first support bosses in a transverse extension direction of the first electrode sheet do not overlap with the two second support bosses in a transverse extension direction of the second electrode sheet.

In the embodiments of the present disclosure, the first support boss and the second support boss are both prepared by a heat pressing or adsorption process, wherein grooves are formed on one side surface of the first substrate by the first support bosses; grooves are formed one side surface of the second substrate by the second support bosses; the first support bosses and the second support bosses respectively have one supporting surface and an annular support sidewall surrounding outside the supporting surface; and the annular support sidewall is an inclined surface.

In the embodiments of the present disclosure, both the first support bosses and the second support bosses are made of water-repellent materials.

In the embodiments of the present disclosure, safety gaps are reserved between the first support bosses and the first conductive layer;
safety gaps are reserved between the second support bosses and the second conductive layer; and the size of the safety gaps is larger than 1 mm.

In the embodiments of the present disclosure, the first support bosses and the second support bosses are separate members and attached to the first substrate and the second substrate respectively.

In the embodiments of the present disclosure, spacing P1 between the two adjacent first support bosses on the same side and a thickness T1 of the first substrate satisfy the following relationship:
P1<35T1; and
spacing P2 between the two adjacent second support bosses on the same side and a thickness T2 of the second substrate satisfy the following relationship:
P2<35T2.

In the embodiments of the present disclosure, the first conductive layer and the second conductive layer are a collection electrode conductive layer and a repelling electrode conductive layer respectively, and a width of the collection electrode conductive layer is larger than a width of the repelling electrode conductive layer.

In the embodiments of the present disclosure, it further includes: a support frame, wherein the support frame has a center shaft, and the first electrode sheet and the second electrode sheet are helically wound outside the center shaft.

In the embodiments of the present disclosure, the first substrate and the second substrate are made of insulating materials.

In the embodiments of the present disclosure, the first substrate and the second substrate are film-like materials.

In the embodiments of the present disclosure, the first conductive layer and the second conductive layer adopt conductive adhesive films.

In the embodiments of the present disclosure, the first conductive layer and the second conductive layer are respectively printed onto the first substrate and the second substrate by using conductive ink.

In the embodiments of the present disclosure, a width of the supporting surface is W, where 1.5 mm≥W≥0.5 mm.

In the embodiments of the present disclosure, an angle θ is formed between the supporting surface and the annular support sidewall, where 10°≥θ≥1°.

In order to solve the above technical problems, the present disclosure further provides an air purification apparatus, including the electrostatic dust collection device.

Compared with the prior art, the technical solutions of the present disclosure have the following effects.

In the electrostatic dust collection device of the present disclosure, the first support bosses and the second support bosses are arranged on the first electrode sheet and the second electrode sheet respectively. After the two electrode sheets are spirally wound and molded, the layered support for the multi-layer electrode sheets is realized by the first support bosses and the second support bosses. During the winding and molding process, it can precisely maintain the fixed spacing without the need for specific tooling to maintain the fixed gap. After the winding and molding process, the layered support structure can be formed by the first support bosses and the second support bosses, which solves the problem of difficulty in ensuring the spacing between the two electrostatic dust collection sheets after the spiral winding and molding. Compared to the prior art, the product can be assembled once the winding is completed, and there is no need for a subsequent processing step, such as dispensing or inserting the isolation comb.

Moreover, the first support bosses and the second support bosses in the present disclosure are respectively arranged on two sides of the first electrode sheet and second electrode sheet, and the first support boss and the second support boss are arranged at intervals in the width directions of the first electrode sheet and the second electrode sheet, which avoids the conductive adhesive film or conductive coating on the substrate, and does not cover the space of the dust collection electric field, so that it does not sacrifice the dust collection efficiency of the collection electrodes. The collection efficiency is further improved compared with that of the electrostatic dust collection device in the prior art.

### BRIEF DESCRIPTION OF DRAWINGS

In order to make the contents of the present disclosure more easily and clearly understood, the following is a further detailed description of the present disclosure according to specific embodiments of the present disclosure and in conjunction with the drawings.

FIG. 1 is a structure schematic diagram of an electrostatic dust collection sheet fixed by a hot melt adhesive in the prior art;

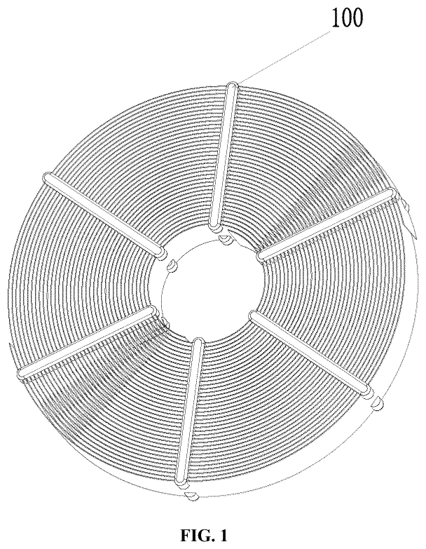

FIG. 2 is a structure schematic diagram of an electrostatic dust collection sheet separated by a spacer in the prior art;

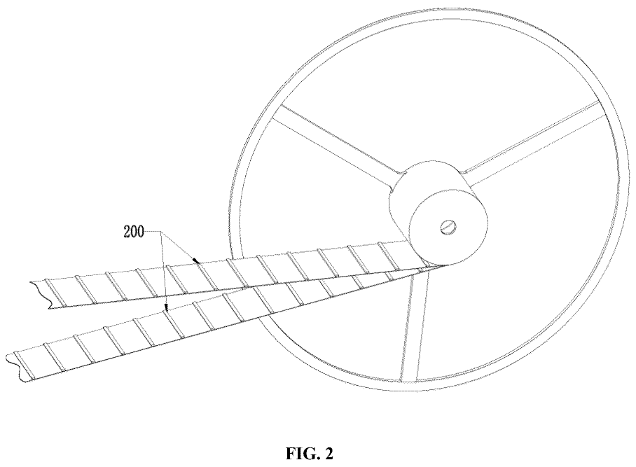

FIG. 3 is a structure schematic diagram of an electrostatic dust collection sheet separated by a comb in the prior art;

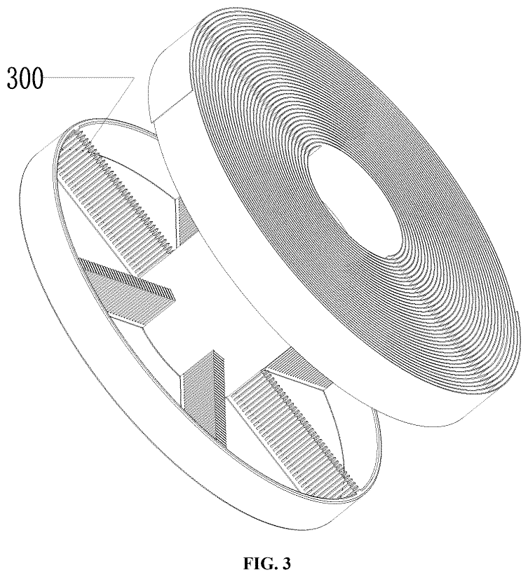

FIG. 4 is a structure schematic diagram of a side view of an electrode sheet of an electrostatic dust collection device before winding in the present disclosure;

FIG. 5 is a structure schematic diagram of a top view of an electrode sheet of an electrostatic dust collection device before winding in the present disclosure;

FIG. 6 is a structure schematic diagram of a side view of an electrode sheet of an electrostatic dust collection device after winding and molding, along with a partially enlarged structure schematic diagram, in the present disclosure;

FIG. 7 is a structure schematic diagram of a top view of a first electrode sheet of the present disclosure;

FIG. 8 is a structure schematic diagram of spacing between two first support bosses on a first electrode sheet of the present disclosure;

FIG. 9 is a structure schematic diagram of a first support boss integrally molded on a first substrate of the present disclosure;

FIG. 10 is a structure schematic diagram of breakage of a first conductive layer when a first support boss is molded of the present disclosure;

FIG. 11 is a structure schematic diagram of a side view of a first electrode sheet of the present disclosure; and

FIG. 12 is a structure schematic diagram of an electrode sheet being wound on a support frame of the present disclosure.

Reference numbers in the specification: 1, first electrode sheet; 11, first substrate; 12, first conductive layer; 2, second electrode sheet; 21, second substrate; 22, second conductive layer; 3, first support boss; 4, second support boss; 5, groove; 6, shortest discharge path; 7, support frame; 100, hot melt adhesive; 200, spacer; and 300, comb-shaped support plate.

### DETAILED DESCRIPTION OF EMBODIMENTS

The present disclosure is further described below in conjunction with the drawings and specific embodiments, so that those skilled in the art can better understand the present disclosure and be able to implement it, but the embodiments given shall not be regarded as limitations to the present disclosure.

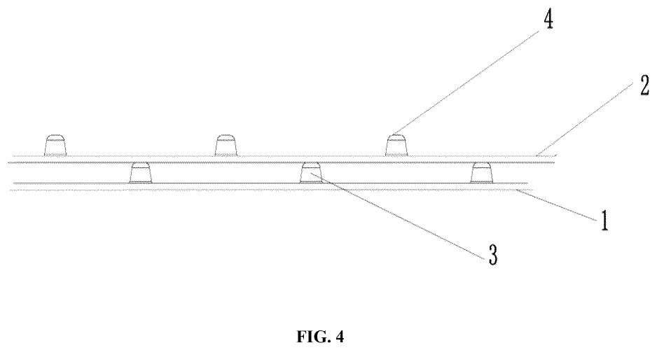

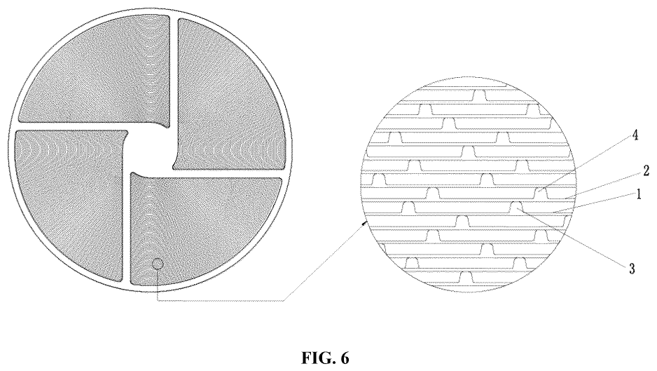

Referring to FIG. 4˜FIG. 6, the present disclosure discloses an electrostatic dust collection device including: a first electrode sheet 1 and a second electrode sheet 2 that are respectively in the form of a strip, wherein a plurality of first support bosses 3 are respectively arranged on two sides of a first surface of the first electrode sheet 1; a plurality of second support bosses 4 are respectively arranged on two sides of a first surface of the second electrode sheet 2; and after a second surface of the first electrode sheet 1 is contacted and stacked on the second support bosses 4 of the second electrode sheet 2, the electrostatic dust collection device is formed by winding.

As described before, the disc-shaped electrostatic dust collection device has many benefits compared to the plate-shaped electrostatic dust collection device, Therefore, the disc-shaped electrostatic dust collection device has become a key research and development direction in the field of dust removal and air purification. However, there are certain defects in the three disc-shaped electrostatic dust collection devices of the prior art. The inventor of the present disclosure has designed the above electrostatic dust collection device to address these defects. Based on these defects, the beneficial effects of the electrostatic dust collection device of the present disclosure are as follows.

First, during the winding process, it needs to use the specific tooling for ensuring the separation of two electrostatic dust collection sheets, so as to maintain the spacing between two electrostatic dust collection sheets. This is very troublesome when winding and is easy to cause the winding failure. After the winding and molding, it further needs to use the hot melt adhesive technology or the comb tooth spacing device for maintaining and fixing the positions of two electrostatic dust collection sheets.

In order to solve this problem, before winding in the present disclosure, a plurality of first support bosses 3 and second support bosses 4 are arranged on one side of the first electrode sheet 1 and the second electrode sheet 2 respectively, and the plurality of first support bosses 3 and second support bosses 4 are arranged at intervals in the longitudinal extension directions of the first electrode sheet 1 and the second electrode sheet 2. In this way, a spacer structure is naturally formed by the first support bosses 3 and the second support bosses 4 during the winding and molding. After the winding and molding, a certain spacing between the first electrode sheet 1 and the second electrode sheet 2 can be maintained, so that there is no need to use specific tooling for the winding process. This can improve the success rate of winding. Moreover, the first support bosses 3 and the second support bosses 4 can continually support the first electrode sheet 1 and the second electrode sheet 2 to separate them. Thus, the product can be assembled once the winding is completed, and there is no need for a subsequent processing step, such as dispensing or inserting the isolation comb.

Second, in the prior art where the spacer is arranged to support between two dust collection sheets, for example, the Korean patent application with publication number KR20180009236A, titled “VORTEX ELECTROSTATIC PRECIPITATOR AND AIR CONDITIONER WITH VOTEX ELECTROSTATIC PRECIPITATOR”, provides a spacer structure. However, during the actual use, the spacer will cover the conductive layer of the dust collection sheet. If the number of the spacers is provided in a small number, it will affect the support effect. If a large number of the spacers are provided to ensure the support strength, a large number of the spacers covering the conductive layer will seriously affect the adsorption effect of the electrostatic dust collection device.

In order to solve this problem, the present disclosure does not use a continuous spaced structure, but a protrusion structure, and the first support bosses 3 and the second support bosses 4 are arranged at intervals along the width directions of the first electrode sheet 1 and the second electrode sheet 2. In the embodiment, the electrode sheet consists of substrates and conductive layers, and the conductive layers cover the substrate.

That is, the first electrode sheet 1 includes: a first substrate 11 and a first conductive layer 12 arranged on one side surface of the first substrate 11. The second electrode sheet 2 includes: a second substrate 21 and a second conductive layer 22 arranged on one side surface of the second substrate 21.

Specifically, the plurality of first support bosses 3 are arranged on two sides of the first conductive layer 12, and the plurality of first support bosses 3 are at the same spacing from the first conductive layer 12. The plurality of second support bosses 4 are arranged on two sides of the second conductive layer 22, and the plurality of second support bosses 4 are at the same spacing from the second conductive layer 22.

The discontinuous support structure of the present disclosure is used to avoid the conductive adhesive film or conductive coating on the substrate, and it does not cover the space of the dust collection electric field. Therefore, the dust collection efficiency of the collection electrodes is not sacrificed, and the collection efficiency is further improved compared with that of the electrostatic dust collection device in the prior art.

Specifically, the substrate is made of the insulating material, and the substrate can isolate the two conductive layers to ensure that no discharge spark phenomenon occurs between the two conductive layers. The conductive layer can be made of a conductive adhesive film (e.g., conductive adhesive films such as aluminum foil, copper foil, and conductive fiber cloth), and it can also be made by a process of printing the conductive ink onto the substrate.

When actually providing the first conductive layer 12 and second conductive layer 22, one of them is provided as a collection electrode conductive layer, and the other is provided as a repelling electrode conductive layer. In order to improve the collection effect, in general, the width D1 of the collection electrode conductive layer is set to be larger than the width D2 of the repelling electrode conductive layer.

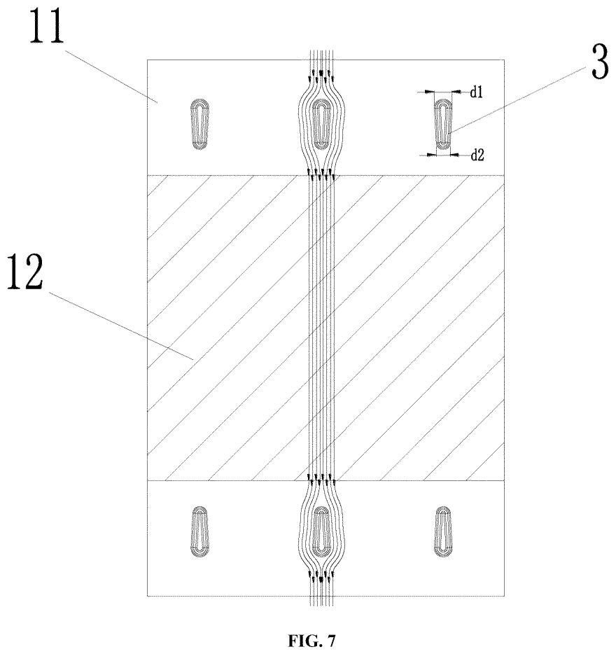

Specifically, the first support boss 3 and the second support boss 4 are both arranged in the gap of the electrode sheet. During the actual use, the airflow can pass through the gap between electrode sheets. Therefore, when arranging the first support boss 3 and the second support boss 4, the issue of air resistance needs also to be considered. Referring to FIG. 7, taking the first support boss 3 arranged on the first electrode sheet 1 as an example, the structure of the first support boss 3 is limited according to principles of aerodynamics. In the embodiment, the first support bosses 3 are arranged extending in a transverse direction of the first electrode sheet 1, where a width d2 of one side of the first support bosses 3 close to the first conductive layer 12 is smaller than a width dl of one side of the first support bosses 3 away from the first conductive layer 12, and the one side of the first support bosses 3 away from the first conductive layer 12 is arranged in the form of a circular arc. When the airflow blows over the first support boss 3, a certain windward angle is formed due to the use of a circular arc-shaped structure, which conforms to the principle of aerodynamics and plays a role in reducing air resistance. Moreover, an inward angle is formed when the airflow blows along the side surface of the first support boss 3, which facilitates the convergence of the airflow on the first conductive layer 12 after flowing through the first support boss 3, and does not cause the airflow to disperse to avoid the first conductive layer 12. This ensures the dust collection efficiency.

Similarly, when the second support boss 4 is arranged on the second electrode sheet 2, the second support boss 4 is arranged extending in a transverse direction of the second electrode sheet 2, wherein a width of one side of the second support boss 4 close to the second conductive layer 22 is smaller than a width of one side of the second support boss 4 away from the second conductive layer 22, and the one side of the second support boss 4 away from the second conductive layer 22 is arranged in the form of a circular arc.

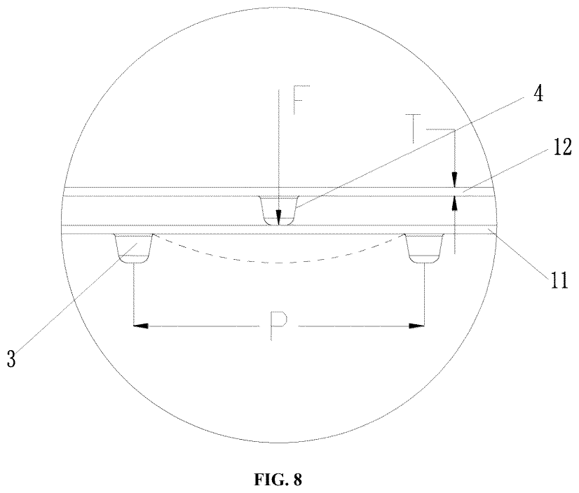

Specifically, the spacing between two adjacent support bosses in the longitudinal direction determines the support effect between the two electrode sheets. During the actual design process, in order to improve the dust collection efficiency and reduce the resistance of airflow, it needs to set the spacing between two support bosses as large as possible under the premise of ensuring that two electrode sheets can be supported and separated. In order to achieve this effect, referring to FIG. 8, taking the two first support bosses 3 on the first electrode sheet 1 supporting the second electrode sheet 2 as an example, the spacing between the two adjacent first support bosses 3 is analyzed, wherein two first support bosses 3 on the first electrode sheet 1 and the second substrate 21 form a mechanical model of a simply supported beam. When the second electrode sheet 2 winds and covers the first electrode sheet 1, the second support boss 4 exerts a pressure F on the center of the simply supported beam, which results in a deformation of the simply supported beam, so that the spacing fails. In order to meet the requirements, after experiments, when the arrangement of the step pitch P of two first support bosses 3 and the thickness T of the substrate satisfies: P<35T, it can provide sufficient support force and does not lead to deformation of the substrate.

Therefore, in the embodiment, the spacing P1 between the two adjacent first support bosses 3 on the same side and the thickness T1 of the first substrate 11 satisfy the following relationship:
P1<35T1.

Similarly, the spacing P2 between the two adjacent second support bosses 4 on the same side and the thickness T2 of the second substrate 21 satisfy the following relationship:
P2<35T2.

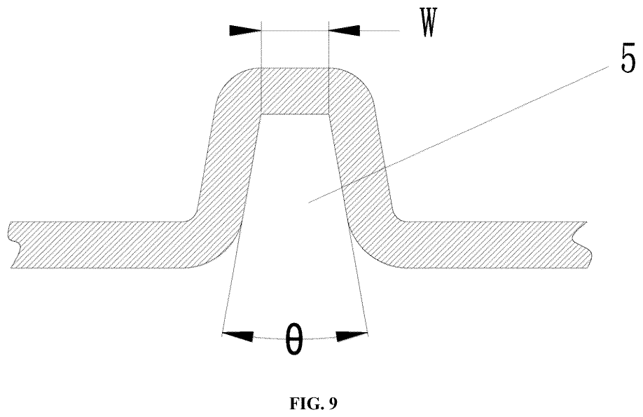

As described above, in the prior art, the spacer needs to be attached or inserted between two dust collection sheets when the spacer is arranged to support the two dust collection sheets. However, a disc-shaped electrostatic dust collection device is formed by winding thousands of spacers, which is complicated for either attachment or insertion. In the present disclosure, when providing the first support bosses 3 and the second support bosses 4, if the method of attaching or inserting is adopted, the process will also be complex. In order to solve the problem, referring to FIG. 9, in the present embodiment, the support bosses and the substrate are integrally molded. That is, the first support bosses 3 and the first substrate 11 are integrally molded, and the second support bosses 4 and the second substrate 21 are integrally molded. In this way, during the preparation of the substrate, the support bosses can be formed on the substrate without the need to attach or insert the support bosses during the winding process, which can improve the production efficiency of the product.

Specifically, the first substrate 11 and the second substrate 12 are film-like materials. Based on the molding process, the first support boss 3 can be prepared from the first substrate 11 by the process such as heat pressing or plastic adsorption, and similarly, the second support boss 4 can also be prepared from the second substrate 21 by the process such as heat pressing or plastic adsorption. However, after molding, grooves 5 corresponding to the first support boss 3 and the second support boss 4 will be formed on the first substrate 11 and the second substrate 21. To prevent the first support boss 3 and the second support boss 4 from entering the grooves 5 during winding, in the embodiment, the positions of the first support boss 3 and the second support boss 4 need to be controlled.

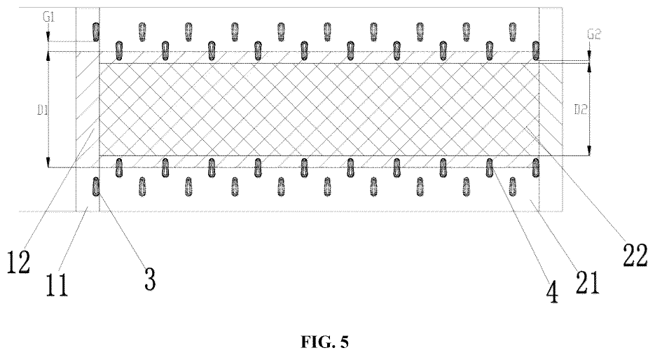

Referring to FIG. 5, in the embodiment, the first support boss 3 and the second support boss 4 are staggered in the space. That is, after the second surface of the first electrode sheet 1 is stacked on the second support boss 4 of the second electrode sheet 2, the second support boss 4 on the second electrode sheet 2 will not enter into the groove 5 on the opposite surface of the first support boss 3 of the first electrode sheet 1, and similarly, the first support boss 3 on the first electrode sheet 1 will not enter into the groove 5 on the opposite surface of the second support boss 4 of the second electrode sheet 2. Only by ensuring that all the bosses will not enter into the groove on the opposite surface of the other boss, the spacing of the electrostatic dust collection can be fixed.

In order to realize the above spatially staggered distribution structure, on the one hand, the spacing between the first support bosses 3 located on two sides of the first electrode sheet 1 can be set to differ from the spacing between the second support bosses 4 located on two sides of the second electrode sheet 2. That is, the first support bosses 3 and the second support bosses 4 are staggered in the transverse direction. On the other hand, along the longitudinal extension direction of the first electrode sheet 1 and the second electrode sheet 2, the positions of the first support bosses 3 and the second support bosses 4 are arranged by a calculation, so that the first support bosses 3 and the second support bosses 4 are staggered after the first electrode sheet 1 and the second electrode sheet 2 are wound.

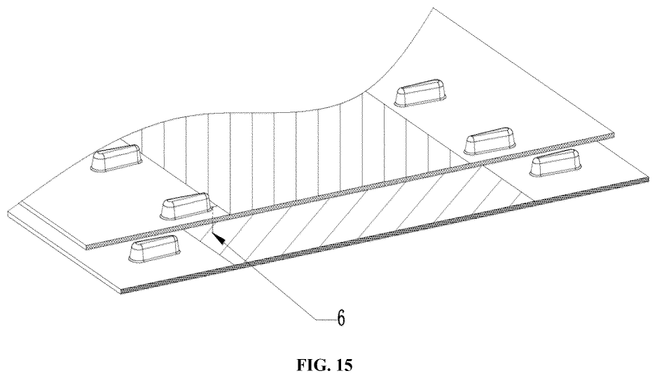

As shown in FIG. 5 and FIG. 10, the first support boss 3 and the second support boss 4 are prepared by the heat pressing or plastic adsorption. The edges of the support bosses are stretched and molded during the molding process of the first support boss 3 and the second support boss 4. This process will shorten the distance between the support bosses and the conductive layer, and in severe cases, the support boss and the conductive layer will be cracked, which results in the occurrence of the shortest discharge path 6 between the conductive layers of the first electrode sheet 1 and the second electrode sheet 2. This is easy to cause the breakdown or discharge under the high-voltage field. Therefore, in the embodiment, the safety gaps are reserved between the first support bosses 3 and the first conductive layer 12. Similarly, the safety gaps are reserved between the second support bosses 4 and the second conductive layer 22. Specifically, the size of the safety gap is larger than 1 mm, i.e., G1 and G2>1 mm, which ensures that the support boss and the conductive layer will not be cracked even if the substrate deforms during the heat pressing or plastic adsorption process.

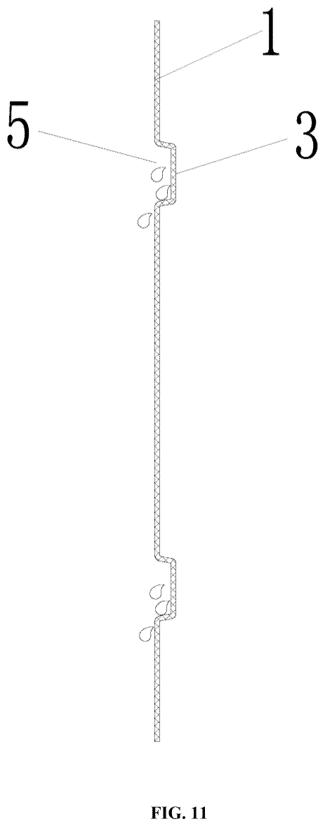

Specifically, after the support bosses and the substrate are integrally molded by the heat pressing or plastic adsorption, the grooves 5 are formed on the substrate. During the actual use, it also needs to maintain a dry environment within the grooves 5 so as to prevent the water accumulation within the grooves 5. Referring to FIG. 9 and FIG. 11, the waterproof design is illustrated by taking the first support boss 3 as an example. The first support boss 3 has a supporting surface and an annular support sidewall surrounding outside the support surface, wherein the width of the supporting surface is W, and an angle θ is formed between the support surface and the annular support sidewall based on the actual processing technology. The size of the first support boss 3 is set to meet the minimum size requirements for the molding process and the mold processing, where 1.5 mm≥W≥0.5 mm, and 10°≥θ≥1°. Additionally, the first support boss 3 is made of water-repellent material with a high water contact angle (WCA). Since the width of the supporting surface is small and the annular support sidewall is an inclined surface, when cleaning the dust collection device, the residual water will be poured out from grooves, which is not easy to form a “quake lake”. The surface dries rapidly after being blown by the purifier air duct system, which greatly shortens the duration of cleaning, maintenance, and drying, so as to improve the user experience.

Similarly, the second support boss 4 also has a supporting surface and an annular support sidewall surrounding outside the supporting surface, wherein the annular support sidewall is an inclined surface, and the second support boss 4 also satisfies the above processing size and the material.

In other embodiments, in order to avoid generating the groove 5, the first support boss 3 and the second support boss 4 can also be separate members and attached to the first substrate 11 and the second substrate 21 respectively, and the use of automatic labeling machine can also realize the automation of labeling.

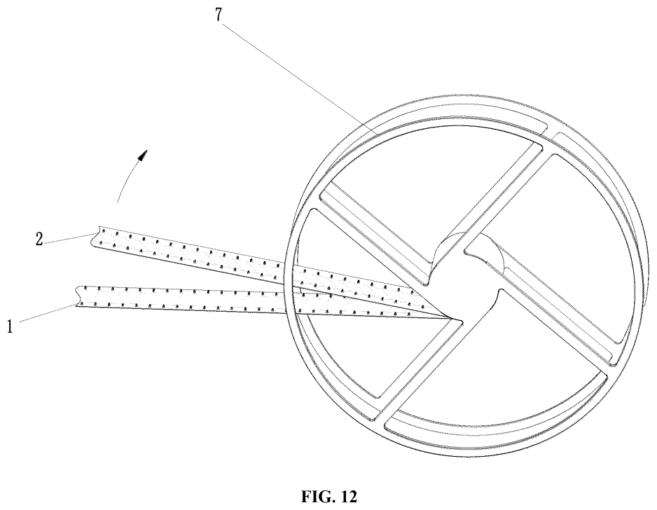

Referring to FIG. 12, the electrostatic dust collection device of the present disclosure further includes: a support frame 7, wherein the support frame 7 has a center shaft, and the first electrode sheet 1 and the second electrode sheet 2 are helically wound outside the center shaft.

Specifically, the present disclosure further provides an air purification apparatus, including the electrostatic dust collection device, wherein the air purification apparatus can be applied to technical fields such as air purification and air dust removal.

Obviously, the above embodiments are merely examples for clear illustration and are not a limitation of the embodiments. Various other variations or changes can be made based on the above description for those of ordinary skill in the art. It is not necessary and cannot be exhaustive herein. Any apparent variation or change resulting therefrom remains within the scope of protection of the present disclosure.

### INDUSTRIAL APPLICABILITY

The present disclosure provides an electrostatic dust collection device and an air purification apparatus. During the winding and molding process, it can precisely maintain the fixed spacing without the need for specific tooling to maintain the fixed gap, which solves the problem of difficulty in ensuring the spacing between the two electrostatic dust collection sheets after the spiral winding and molding, and simplifies the subsequent processing step.

Additionally, it can be understood that the electrostatic dust collection device and air purification apparatus of the present disclosure are reproducible and can be widely applied in the technical field of electrostatic dust collection.

1-20. (canceled)

21. An electrostatic dust collection device, comprising:
a first electrode sheet and a second electrode sheet respectively in a form of a strip, wherein a plurality of first support bosses are respectively arranged on two sides of a first surface of the first electrode sheet; a plurality of second support bosses are respectively arranged on two sides of a first surface of the second electrode sheet; and after a second surface of the first electrode sheet is contacted and stacked on the second support bosses of the second electrode sheet, the electrostatic dust collection device is formed by winding;
the first electrode sheet comprises: a first substrate and a first conductive layer arranged on one side surface of the first substrate, wherein the plurality of first support bosses are arranged on two sides of the first conductive layer, and the plurality of first support bosses are at a same distance from the first conductive layer; and
the second electrode sheet comprises: a second substrate and a second conductive layer arranged on one side surface of the second substrate, wherein the plurality of second support bosses are arranged on two sides of the second conductive layer, and the plurality of second support bosses are at a same distance from the second conductive layer.

22. The electrostatic dust collection device according to claim 21, wherein
the first support bosses are arranged to extend in a transverse direction of the first electrode sheet, a width of one side of the first support bosses close to the first conductive layer is smaller than a width of one side of the first support bosses away from the first conductive layer, and the side of the first support bosses away from the first conductive layer is arranged in a form of a circular arc; and
the second support bosses are arranged to extend in a transverse direction of the second electrode sheet, a width of one side of the second support bosses close to the second conductive layer is smaller than a width of one side of the second support bosses away from the second conductive layer, and the side of the second support bosses away from the second conductive layer is arranged in the form of a circular arc.

23. The electrostatic dust collection device according to claim 21, wherein
the first support bosses and the first substrate are integrally molded; and
the second support bosses and the second substrate are integrally molded.

24. The electrostatic dust collection device according to claim 23, wherein, after the first electrode sheet and the second electrode sheet are wound and molded, the first support bosses on the first electrode sheet and the second support bosses on the second electrode sheet, which are in adjacent layers, are staggered to each other.

25. The electrostatic dust collection device according to claim 24, wherein the two first support bosses in a transverse extension direction of the first electrode sheet do not overlap with the two second support bosses in a transverse extension direction of the second electrode sheet.

26. The electrostatic dust collection device according to claim 23, wherein the first support bosses and the second support bosses are both prepared by a heat pressing or adsorption process; the first support bosses form grooves on one side surface of the first substrate; the second support bosses form grooves on one side surface of the second substrate; the first support boss and the second support boss each has a supporting surface and an annular support sidewall surrounding outside the supporting surface; and the annular support sidewall is an inclined surface.

27. The electrostatic dust collection device according to claim 23, wherein both the first support bosses and the second support bosses are made of water-repellent materials.

28. The electrostatic dust collection device according to claim 24, wherein
safety gaps are reserved between the first support bosses and the first conductive layer;
safety gaps are reserved between the second support bosses and the second conductive layer; and
a size of the safety gaps is larger than 1 mm.

29. The electrostatic dust collection device according to claim 21, wherein the first support bosses and the second support bosses are separate members and attached to the first substrate and the second substrate respectively.

30. The electrostatic dust collection device according to claim 21, wherein
a spacing P1 between the two adjacent first support bosses on a same side, along with a thickness T1 of the first substrate, satisfies following relationship:
P1<35T1; and
a spacing P2 between the two adjacent second support bosses on the same side, along with a thickness T2 of the second substrate, satisfies following relationship:
P2<35T2.

31. The electrostatic dust collection device according to claim 21, wherein the first conductive layer and the second conductive layer are a collection electrode conductive layer and a repelling electrode conductive layer respectively, and a width of the collection electrode conductive layer is larger than a width of the repelling electrode conductive layer.

32. The electrostatic dust collection device according to claim 21, further comprising: a support frame, wherein the support frame has a center shaft, and the first electrode sheet and the second electrode sheet are helically wound outside the center shaft.

33. An air purification apparatus, comprising: the electrostatic dust collection device according to claim 21.
